(19) United States
(12) Patent Application Publication
(10) Pub. No.: US 2025/0358735 A1
(43) Pub. Date: Nov. 20, 2025

(54) Methods And Apparatus For Provision Of Eco-Rating Information In Mobile Communications

(71) Applicant: MediaTek Inc., Hsinchu City (TW)

(72) Inventors: Chien-Sheng Yang, Hsinchu City (TW); Yu-Hsin Lin, Hsinchu City (TW); Yuan-Chieh Lin, Hsinchu City (TW); Chia-Lin Lai, Hsinchu City (TW)

(21) Appl. No.: 19/207,432

(22) Filed: May 14, 2025

Related U.S. Application Data
(60) Provisional application No. 63/648,730, filed on May 17, 2024.

(51) Int. Cl. H04W 52/02

(52) U.S. Cl. CPC H04W 52/0209

(57) ABSTRACT

Various solutions for provision of eco-rating information in mobile communications are described. A terminal equipment (TE) may transmit a request message to a terminal adapter (TA). The request may include an indication to request or enable the TA to retrieve eco-rating information of a subscribed communication service from a mobile termination (MT). The TE may receive a response message from the TA. The response message may include the eco-rating information of the subscribed communication service. Then, the TE may provide a representation of the eco-rating information.

### CROSS REFERENCE TO RELATED PATENT APPLICATION(S)

The present disclosure is part of a non-provisional application claiming the priority benefit of U.S. Patent Application No. 63/648,730, filed 17 May 2024, the content of which herein being incorporated by reference in its entirety.

### TECHNICAL FIELD

The present disclosure is generally related to mobile communications and, more particularly, to providing users with eco-rating information in mobile communications.

### BACKGROUND

Unless otherwise indicated herein, approaches described in this section are not prior art to the claims listed below and are not admitted as prior art by inclusion in this section.

The primary driver for climate change is the substantial release of greenhouse gases (GHG), such as carbon dioxide (CO2), resulting from human activities like the combustion of fossil fuels to generate electricity. This change presents a profound risk to both society and the natural world. The rapid expansion of service demands within networks has been fueled by recent breakthroughs in cellular technologies, including 4th generation (4G) and 5th generation (5G) systems, which support a wide range of applications. By year 2040, the Information/Communications Technology (ICT) sector is projected to consume 20% of the world's energy. As a pivotal entity in the ICT industry, the 3^{rd} Generation Partnership Project (3GPP) is instrumental in the worldwide implementation of these technologies and, consequently, must assume a central role in fostering a sustainable future.

Currently, there are several key approaches that are essential to minimize carbon footprints, such as improving energy efficiency to reduce overall consumption, and increasing the use of renewable energy sources like solar and wind power, which do not emit carbon dioxide during electricity generation. In general, the energy powering networks come from a variety of sources, each with its own environmental impact. Given the inherently fluctuating and unpredictable nature of renewable energy, its availability significantly differs across times and locations.

As climate change concerns intensify and environmental awareness rises, today's consumers are actively seeking to understand the carbon footprint associated with their actions, including the products they purchase and the communication services to which they subscribe, empowering them to make more sustainable choices. Hence, providing users with information by mobile operators based on the energy-related characteristics of the network, such as energy consumption, the mix of different energy sources, carbon footprint, and the conditions of energy capacity and availability, is crucial for a deeper understanding of the environmental impact of their subscribed services. However, in the market of mobile communications, users currently lack indicators that inform them about the environmental impacts of their subscribed services.

Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and/or apparatus pertaining to provision of eco-rating information in mobile communications. It is believed that the above-described issue would be avoided or otherwise alleviated by implementing one or more of the proposed schemes described herein.

In one aspect, a method may involve a terminal equipment (TE) transmitting a request message to a terminal adapter (TA), wherein the request comprises an indication to request or enable the TA to retrieve eco-rating information of a subscribed communication service from a mobile termination (MT). The method may also involve the TE receiving a response message from the TA, wherein the response message comprises the eco-rating information of the subscribed communication service. The method may further involve the TE providing a representation of the eco-rating information.

In one aspect, a method may involve a terminal adapter (TA) receiving a request message from a TE, wherein the request comprises an indication to request or enable the TA to retrieve eco-rating information of a subscribed communication service from an MT. The method may also involve the TA retrieving the eco-rating information of the subscribed communication service from the MT according to the request message. The method may further involve the TA transmitting a response message to the TE, wherein the response message comprises the eco-rating information of the subscribed communication service.

In one aspect, an apparatus, operating as a TE, may comprise a processor which, during operation, may perform operations comprising transmitting a request message to a TA, wherein the request comprises an indication to request or enable the TA to retrieve eco-rating information of a subscribed communication service from an MT. The processor may also perform operations comprising receiving a response message from the TA, wherein the response message comprises the eco-rating information of the subscribed communication service. The processor may further perform operations comprising providing a representation of the eco-rating information.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of a signaling architecture for AT commands in accordance with an implementation of the present disclosure.

FIG. 3 is a diagram depicting another example scenario of providing eco-rating information in a user interface in accordance with an implementation of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to provision of eco-rating information in mobile communications. According to the present disclosure, a number of possible solutions may be implemented separately or jointly. That is, although these possible solutions may be described below separately, two or more of these possible solutions may be implemented in one combination or another.

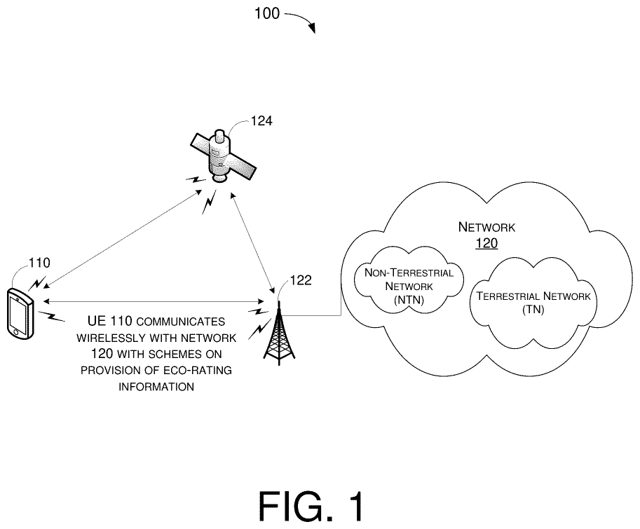

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including a non-terrestrial network (NTN) and a TN) via at least a terrestrial network node 122 (e.g., a base station (BS) such as an evolved Node-B (eNB), a Next Generation Node-B (gNB), or a transmission/reception point (TRP)) and/or at least a non-terrestrial network node 124 (e.g., a satellite). For example, the terrestrial network node 122 may form a TN serving cell for wireless communication with the UE 110, or the terrestrial network node 122 and/or the non-terrestrial network node 124 may form an NTN serving cell for wireless communication with the UE 110. In some implementations, the network 120 may be a 4G/5G/B5G/6G network, and the UE 110 may be a smartphone, a tablet computer, a laptop computer, a notebook computer, or any combination thereof. Alternatively, the network 120 may be an IoT/NB-IoT/IIoT network, and the UE 110 may be an IoT device such as an NB-IoT UE or an enhanced machine-type communication (eMTC) UE (e.g., a bandwidth reduced low complexity (BL) UE or a coverage enhancement (CE) UE). Although not shown, the TN part of the network 120 may include a core network (CN) containing various network functions (NFs) for at least providing eco-rating information. For example, if the network 120 is a 5G system (5GS), the NFs may include an access and mobility function (AMF), a session management function (SMF), a policy control function (PCF), an operations and maintenance (OAM) entity, a network data analytics function (NWDAF), an application function (AF), a unified data management (UDM), a unified data repository (UDR), and an energy information function (EIF), etc. In such communication environment, the UE 110, the network 120, the terrestrial network node 122, and/or the non-terrestrial network node 124 may implement various schemes pertaining to provision of eco-rating information in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In particular, the present disclosure addresses the requirements in 3GPP standards as follows: (i) subject to operator's policy, the 5G system shall support a mechanism for providing the indication about energy-related characteristics for the subscribed communication service to an authorized user; and (ii) subject to operator's policy, the 5G system shall support a means to associate energy-related characteristics with charging information based on subscription policies for the subscribed services.

In view of the above-described issue, the present disclosure proposes a number of schemes pertaining to provision of eco-rating information in mobile communications. According to the schemes of the present disclosure, AT commands for acquisition of eco-rating information are proposed to allow the UE to be able to provide the eco-rating information of a subscribed communication service to the user. Accordingly, by applying the schemes of the present disclosure, the user may be informed of the information regarding the energy-related characteristics of the network, such as energy consumption, the mix of energy sources, carbon footprint, and the conditions of energy capacity and availability.

In some implementations, the eco-rating information may include at least one of the following: (i) energy efficiency information; (ii) energy consumption information; (iii) carbon emission information; and (iv) renewable energy information.

In some implementations, the eco-rating information may be associated with at least one of a wireless network, a network slice, a protocol data unit (PDU) session, a quality-of-service (QOS) flow, and a radio bearer corresponding to the subscribed communication service.

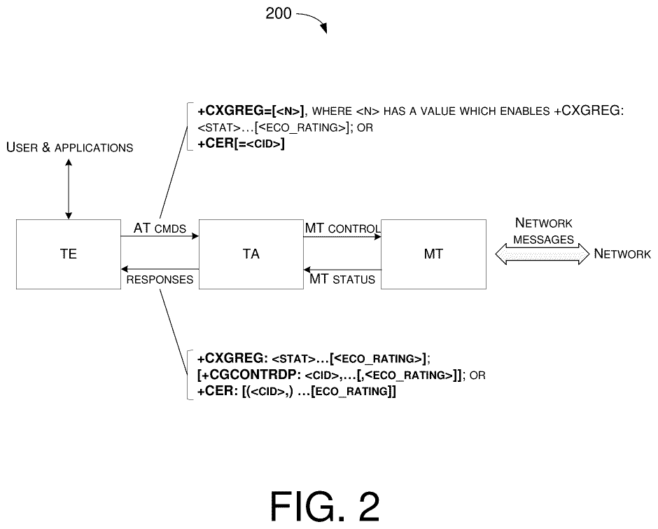

FIG. 2 illustrates an example scenario 200 of a signaling architecture for AT commands in accordance with an implementation of the present disclosure. Scenario 200 depicts an abstract architecture including a TE and an MT interfaced by a TA, where the AT commands are used for controlling MT functions and network services from the TE through the TA. Specifically, the TE (e.g., a UE, or an application processor (AP) of a computer) may transmit an AT command requesting or enabling the TA to retrieve eco-rating information of a subscribed communication service from the MT, wherein the TA and/or the MT may be a UE or a modem. In response, the TA may retrieve the eco-rating information of the subscribed communication service from the MT via MT control and status messages. Then, the TA may transmit a response message (e.g., an unsolicited result code, an intermediate response, or a final response) containing the eco-rating information of the subscribed communication service to the TE. It should be noted that the span of control of the AT commands should allow handling of any physical implementation. For example, the TA, the MT and the TE may be implemented as three separate entities, or the TA may be integrated under the MT cover while the TE is implemented as a separate entity. Alternatively, the TA may be integrated under the TE cover while the MT is implemented as a separate entity, or both the TA and the MT may be integrated under the TE cover as a single entity.

In some implementations, the AT command may be a set command +CXGREG (e.g., +CEGREG, +C5GREG, or +C6GREG) for querying network registration status, which comprises a context identifier <n> with a value that enables an unsolicited result code+CXGREG: <stat> . . . [<eco_rating>].

In some implementations, the AT command may be a newly introduced execution command+CER [=<cid>] which returns the eco-rating information (of a network or for an active non-secondary PDP context or a QoS flow of the default QoS rule with the context identifier <cid>).

In some implementations, the response message may be an unsolicited result code+CXGREG: <stat> . . . [<eco_rating>].

In some implementations, the response message may be a (intermediate/final) response [+CGCONTRDP: <cid>, . . . [,<eco_rating>]] for packet data protocol (PDP) context read dynamic parameters.

In some implementations, the response message may be a newly introduced (intermediate/final) response+CER: [(<cid>,) . . . [eco_rating]].

In some implementations, <eco_rating> is a context identifier of an integer/string type value for indicating the eco-rating information (e.g., the eco rating of the network, service, PDU session, QoS flow, radio bearer corresponding to <cid>).

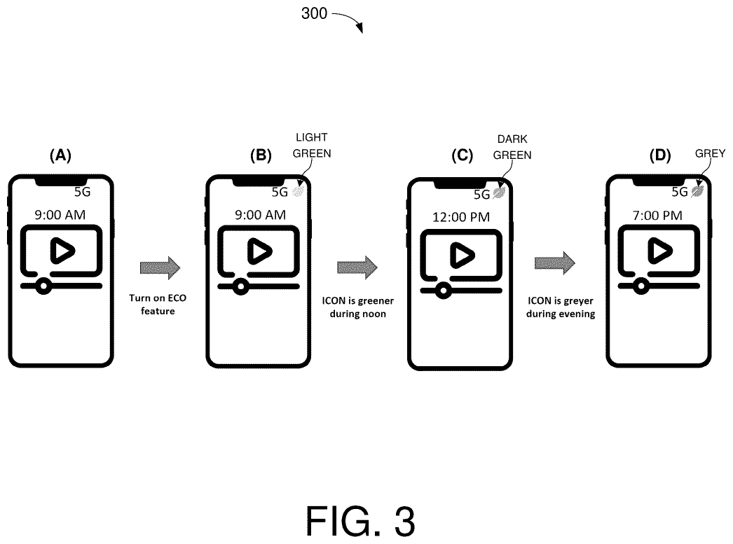

FIG. 3 illustrates an example scenario 300 of providing eco-rating information in a (graphical) user interface in accordance with an implementation of the present disclosure. Scenario 300 depicts an exemplary use case where the user, Eva, is watching videos during the commute and receives 5G service from the mobile network operator A, as shown in part (A) of FIG. 3. As a forward-thinking operator that prides itself on the sustainability of its 3GPP network, operator A offers a distinctive “ECO feature” that could shed light on the environmental impact of users' subscribed services. The user, Eva, an environmentally conscious individual, is passionate about reducing her carbon footprint and making eco-friendly choices. Thus, Eva is thrilled to discover that operator A is offering this unique feature that can inform her about the environmental impact of her subscribed services. Eager to understand how her digital footprint affects the planet, she happily activated this feature. Upon activation of the ECO feature, a distinctive indicator (e.g., a value or an icon) appears on her mobile phone's screen, serving as a visual representation of how “green” her subscribed service is (i.e., the eco-rating information) at any given moment. This innovative indicator, such as an icon, may dynamically change based on eco-rating information received from operator A, and is designed to reflect the energy-related characteristics of the network powering her subscribed service. To indicate a lower environmental impact (meaning higher energy efficiency, less energy consumption, fewer carbon emissions, or more renewable energy), the icon on the phone could be depicted as a green leaf in different shades for indicating different level of environmental impact; or conversely, a grey leaf could represent a higher environmental impact. For example, during the early morning when there is plentiful solar energy powering operator A's system for providing communication service, the icon is a light green leaf (indicating the presence of solar energy powering), as shown in part (B) of FIG. 3. At noon when sunlight is strongest during the day, the icon becomes greener (indicating the abundance of solar energy powering), as shown in part (C) of FIG. 3. During the evening when there is no solar energy at the moment, the icon becomes gray (reflecting the absence of solar energy at that time), as shown in part (D) of FIG. 3. The eco-rating information may be generated by taking into account various factors such as energy consumption, the mix of energy sources fueling the network (renewables vs. non-renewables), the carbon footprint associated with her data usage, and even the energy capacity and availability conditions at different times of the day. Accordingly, the ECO feature (along with the displayed icon) not only provides Eva with a constant reminder of her environmental impact but also empowers her to make informed decisions about her digital behavior.

### Illustrative Implementations

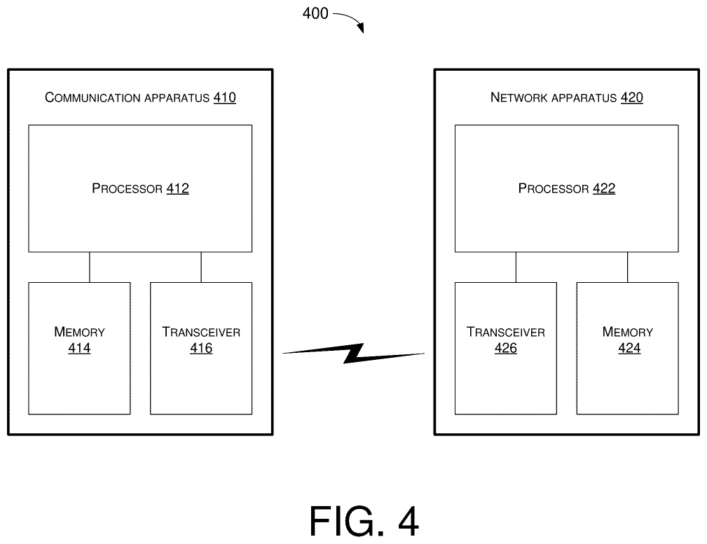

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to provision of eco-rating information in mobile communications, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 410 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed schemes of the present disclosure (e.g., internal power supply, display device, AT interface and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a satellite, a BS, a small cell, a router, a gateway or an NF of a wireless network. For instance, network apparatus 420 may be implemented in a satellite or an eNB/gNB/TRP in a 4G/5G/B5G/6G, NR, IoT, NB-IoT or IIoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. For example, processor 412 may be an application processor (AP) or any processor in which a TE entity and/or a TA entity may be implemented. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks, including provision of eco-rating information, in a device (e.g., as represented by communication apparatus 410) and a network node (e.g., as represented by network apparatus 420) in accordance with various implementations of the present disclosure.

In some implementations, communication apparatus 410 may also include a transceiver 416 (e.g., a modem, or an MT entity and/or a TA entity) coupled to processor 412 and capable of wirelessly transmitting and receiving data. In some implementations, transceiver 416 may be capable of wirelessly communicating with different types of UEs and/or wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, network apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, communication apparatus 410 may further include a memory 414 coupled to processor 412 and capable of being accessed by processor 412 and storing data (e.g., eco-rating information) therein. In some implementations, network apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 410 and network apparatus 420 may be a communication entity capable of communicating with each other using various proposed schemes in accordance with the present disclosure. For illustrative purposes and without limitation, a description of capabilities of communication apparatus 410, as a UE, and network apparatus 420, as a network node (e.g., AMF/UPF), is provided below with processes 500 and 600.

### Illustrative Processes

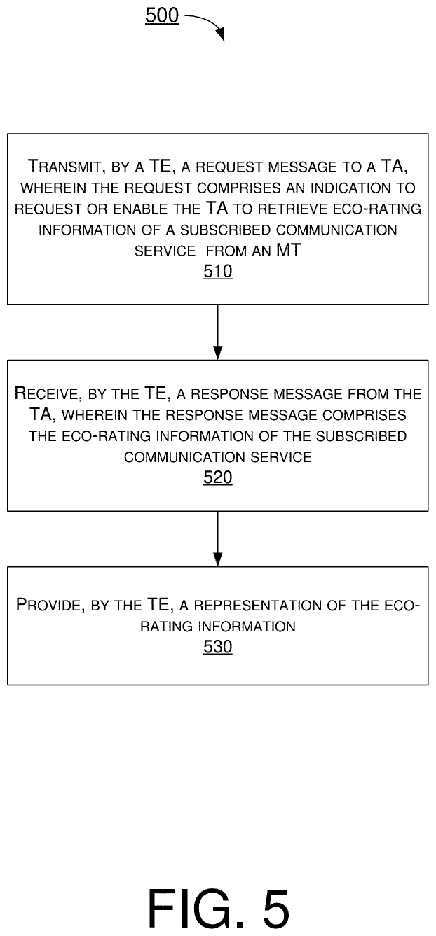

FIG. 5 illustrates an example process 500 in accordance with an implementation of the present disclosure. Process 500 may be an example implementation of above scenarios/schemes, whether partially or completely, with respect to provision of eco-rating information in mobile communications. Process 500 may represent an aspect of implementation of features of a TE. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by or in communication apparatus 410 or any suitable UE or machine type device. Solely for illustrative purposes and without limiting the scope, process 500 is described below in the context of communication apparatus 410, operating as a TE. Process 500 may begin at block 510.

At 510, process 500 may involve processor 412 of communication apparatus 410, transmitting a request message to a TA, wherein the request message comprises an indication to request or enable the TA to retrieve eco-rating information of a subscribed communication service from an MT. Process 500 may proceed from 510 to 520.

At 520, process 500 may involve processor 412 receiving a response message from the TA, wherein the response message comprises the eco-rating information of the subscribed communication service. Process 500 may proceed from 520 to 530.

At 530, process 500 may involve processor 412 providing a representation of the eco-rating information (e.g., to user or application).

In some implementations, the eco-rating information may include at least one of the following: (i) energy efficiency information; (ii) energy consumption information; (iii) carbon emission information; and (iv) renewable energy information.

In some implementations, the eco-rating information may be associated with at least one of a wireless network, a network slice, a PDU session, a QoS flow, and a radio bearer corresponding to the subscribed communication service.

In some implementations, each of the request message and the response message may be an AT command, and the response message may include an unsolicited result code, an intermediate response, or a final response.

In some implementations, the request message may include one of the following: (i) a set command for querying network registration status (e.g., +CEGREG, +C5GREG, or +C6GREG), which comprises a context identifier <n> with a value that enables an unsolicited result code+CEGREG, +C5GREG, or +C6GREG with a context identifier for indicating the eco-rating information; and (ii) an execution command+CER for requesting the eco-rating information.

In some implementations, the response message may include one of the following: (i) an unsolicited result code+CEGREG, +C5GREG, or +C6GREG with a context identifier for indicating the eco-rating information; (ii) a response [+CGCONTRDP] for packet data protocol (PDP) context read dynamic parameters, which comprises a context identifier for indicating the eco-rating information; and (iii) a response+CER which comprises a context identifier for indicating the eco-rating information.

In some implementations, the eco-rating information retrieved from the MT may be received from a wireless network that the MT is registered with.

In some implementations, the representation of the eco-rating information may include an icon, a value, or an indicator for indicating the eco-rating information.

In some implementations, the providing of the representation of the eco-rating information may include changing a color of the icon, the value, or the indicator according to the eco-rating information.

In some implementations, the color of the icon, the value, or the indicator may change to a first state (e.g., the color of the icon becomes greener) in an event that the eco-rating information indicates a higher rating of energy efficiency or renewable energy (e.g., energy efficiency higher than a threshold, or percentage of renewable energy higher than a threshold), or indicates a lower rating of energy consumption or carbon emission (e.g., energy consumption lower than a threshold, or carbon emission lower than a threshold). Additionally or optionally, the color of the icon, the value, or the indicator may change to a second state (e.g., the color of the icon becomes greyer) in an event that the eco-rating information indicates a lower rating of energy efficiency or renewable energy (e.g., energy efficiency lower than a threshold, percentage of renewable energy lower than a threshold) or indicates a higher rating of energy consumption or carbon emission (e.g., energy consumption higher than a threshold, or carbon emission higher than a threshold).

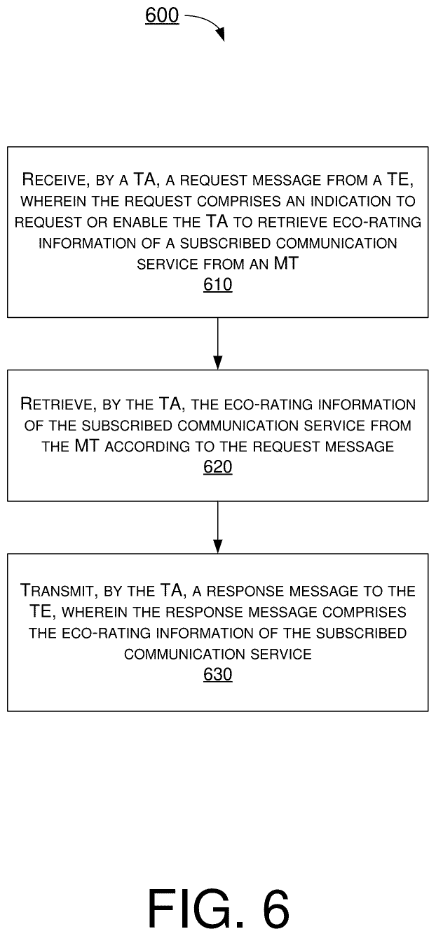

FIG. 6 illustrates an example process 600 under schemes in accordance with an implementation of the present disclosure. Process 600 may represent an aspect of implementing various proposed designs, concepts, schemes, systems and methods described above, whether partially or entirely, with respect to provision of eco-rating information in mobile communications. Process 600 may represent an aspect of implementation of features of a TA. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively, in a different order. Process 600 may be implemented by or in communication apparatus 410 or any suitable UE or machine type device. Solely for illustrative purposes and without limiting the scope, process 600 is described below in the context of communication apparatus 410, operating as a TA. Process 600 may begin at block 610.

At 610, process 600 may involve processor 412 of communication apparatus 410, receiving, a request message from a TE, wherein the request message comprises an indication to request or enable the TA to retrieve eco-rating information of a subscribed communication service from an MT. Process 600 may proceed from 610 to 620.

At 620, process 600 may involve processor 412 retrieving the eco-rating information of the subscribed communication service from the MT according to the request message. Process 600 may proceed from 620 to 630.

At 630, process 600 may involve processor 412 transmitting a response message to the TE, wherein the response message comprises the eco-rating information of the subscribed communication service.

In some implementations, the eco-rating information may be associated with at least one of a wireless network, a network slice, a PDU session, a QoS flow, and a radio bearer corresponding to the subscribed communication service.

In some implementations, each of the request message and the response message may be an AT command, and the response message may include an unsolicited result code, an intermediate response, or a final response.

In some implementations, the request message may include one of the following: (i) a set command for querying network registration status (e.g., +CEGREG, +C5GREG, or +C6GREG), which comprises a context identifier <n> with a value that enables an unsolicited result code+CEGREG, +C5GREG, or +C6GREG with a context identifier for indicating the eco-rating information; and (ii) an execution command+CER for requesting the eco-rating information.

In some implementations, the response message may include one of the following: (i) an unsolicited result code+CEGREG, +C5GREG, or +C6GREG with a context identifier for indicating the eco-rating information; (ii) a response [+CGCONTRDP] for packet data protocol (PDP) context read dynamic parameters, which comprises a context identifier for indicating the eco-rating information; and (iii) a response+CER which comprises a context identifier for indicating the eco-rating information.

In some implementations, the eco-rating information retrieved from the MT may be received from a wireless network that the MT is registered with.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a terminal equipment (TE), a request message to a terminal adapter (TA), wherein the request message comprises an indication to request or enable the TA to retrieve eco-rating information of a subscribed communication service from a mobile termination (MT);
receiving, by the TE, a response message from the TA, wherein the response message comprises the eco-rating information of the subscribed communication service; and
providing, by the TE, a representation of the eco-rating information.

2. The method of claim 1, wherein the eco-rating information comprises at least one of the following:
energy efficiency information;
energy consumption information;
carbon emission information; and
renewable energy information.

3. The method of claim 1, wherein the eco-rating information is associated with at least one of the following:
a wireless network corresponding to the subscribed communication service;
a network slice corresponding to the subscribed communication service;
a protocol data unit (PDU) session corresponding to the subscribed communication service;
a quality-of-service (QOS) flow corresponding to the subscribed communication service; and
a radio bearer corresponding to the subscribed communication service.

4. The method of claim 1, wherein each of the request message and the response message is an attention (AT) command, and the response message comprises an unsolicited result code, an intermediate response, or a final response.

5. The method of claim 4, wherein the request message comprises one of the following:
a set command for querying network registration status, which comprises a context identifier with a value that enables an unsolicited result code with a context identifier for indicating the eco-rating information; and
an execution command for requesting the eco-rating information.

6. The method of claim 5, wherein the response message comprises one of the following:
the unsolicited result code which comprises the context identifier for indicating the eco-rating information;
which comprises a context identifier for indicating the eco-rating information; and
a response to the execution command, which comprises a context identifier for indicating the eco-rating information.

7. The method of claim 1, wherein the eco-rating information retrieved from the MT is received from a wireless network that the MT is registered with.

8. The method of claim 1, wherein the representation of the eco-rating information comprises an icon, a value, or an indicator for indicating the eco-rating information.

9. The method of claim 8, wherein the providing of the representation of the eco-rating information comprises:
changing a color of the icon, the value, or the indicator according to the eco-rating information.

10. The method of claim 9, wherein:
the color of the icon, the value, or the indicator changes to a first state in an event that the eco-rating information indicates a higher rating of energy efficiency or renewable energy, or indicates a lower rating of energy consumption or carbon emission; or
the color of the icon, the value, or the indicator changes to a second state in an event that the eco-rating information indicates a lower rating of energy efficiency or renewable energy or indicates a higher rating of energy consumption or carbon emission.

11. A method, comprising:
receiving, by a terminal adapter (TA), a request message from a terminal equipment (TE), wherein the request message comprises an indication to request or enable the TA to retrieve eco-rating information of a subscribed communication service from a mobile termination (MT);
retrieving, by the TA, the eco-rating information of the subscribed communication service from the MT according to the request message; and
transmitting, by the TA, a response message to the TE, wherein the response message comprises the eco-rating information of the subscribed communication service.

12. The method of claim 11, wherein the eco-rating information comprises at least one of the following:
energy efficiency information;
energy consumption information;
carbon emission information; and
renewable energy information.

13. The method of claim 11, wherein the eco-rating information is associated with at least one of the following:
a wireless network corresponding to the subscribed communication service;
a network slice corresponding to the subscribed communication service;
a protocol data unit (PDU) session corresponding to the subscribed communication service;
a quality-of-service (QOS) flow corresponding to the subscribed communication service; and
a radio bearer corresponding to the subscribed communication service.

14. The method of claim 11, wherein each of the request message and the response message is an attention (AT) command, and the response message comprises an unsolicited result code, an intermediate response, or a final response.

15. The method of claim 14, wherein the request message comprises one of the following:
a set command for querying network registration status, which comprises a context identifier <n> with a value that enables an unsolicited result code with a context identifier for indicating the eco-rating information; and
an execution command for requesting the eco-rating information.

16. The method of claim 15, wherein the response message comprises one of the following:
the unsolicited result code which comprises the context identifier for indicating the eco-rating information;
which comprises a context identifier for indicating the eco-rating information; and
a response to the execution command, which comprises a context identifier for indicating the eco-rating information.

17. The method of claim 11, wherein the eco-rating information retrieved from the MT is received from a wireless network that the MT is registered with.

18. An apparatus, operating as a terminal equipment (TE), comprising:
a processor which, during operation, performs operations comprising:
transmitting a request message to a terminal adapter (TA), wherein the request message comprises an indication to request or enable the TA to retrieve eco-rating information of a subscribed communication service from a mobile termination (MT);
receiving a response message from the TA, wherein the response message comprises the eco-rating information of the subscribed communication service; and
providing a representation of the eco-rating information.

19. The apparatus of claim 18, wherein each of the request message and the response message is an attention (AT) command, and the response message comprises an unsolicited result code, an intermediate response, or a final response.

20. The apparatus of claim 19, wherein the request message comprises one of the following:
a set command for querying network registration status, which comprises a context identifier <n> with a value that enables an unsolicited result code with a context identifier for indicating the eco-rating information; and
an execution command for requesting the eco-rating information; and
wherein the response message comprises one of the following:
the unsolicited result code which comprises the context identifier for indicating the eco-rating information;
a response for packet data protocol (PDP) context read dynamic parameters, which comprises a context identifier for indicating the eco-rating information; and
a response to the execution command, which comprises a context identifier for indicating the eco-rating information.
